(19) United States
(12) Patent Application Publication
(10) Pub. No.: US 2006/0083437 A1
(43) Pub. Date: Apr. 20, 2006

(54) Three-dimensional image display apparatus

(75) Inventors: Sung-yong Jung, Suwon-si (KR); Sergey Shestak, Suwon-si (KR); Sung-sik Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/216,145

(22) Filed: Sep. 1, 2005

(30) Foreign Application Priority Data
Sep. 1, 2004 (KR) 10-2004-0069559

(51) Int. Cl. G06K 9/46; G06K 9/36

(52) U.S. Cl. 382/243

(57) ABSTRACT

A three-dimensional image display apparatus is provided which uses a multi-facet flat mirror which includes an image pickup unit and an image display unit. The image pickup unit includes a first beam splitter changing paths of beams incident from a three-dimensional object, a first multi-facet flat mirror forming a concave structure with a combination of a plurality of basic flat mirrors, and an image pickup device picking up as a two-dimensional basic image signal beams that are reflected by the first multi-facet flat mirror array. The image display unit includes a beam projector receiving the two-dimensional basic image signal and projecting the received signal, a second beam splitter changing propagation paths of incident beams, and a second multi-facet flat mirror array forming a concave structure with a combination of a plurality of basic flat mirrors and restoring the input two-dimensional signal into a three-dimensional image signal.

### CROSS REFERENCE TO RELATED APPLICATIONS

This application claims priority from Korean Patent Application No. 10-2004-0069559, filed on Sep. 1, 2004, in the Korean Intellectual Property Office, the disclosure of which is incorporated herein in its entirety by reference.

### BACKGROUND OF THE INVENTION

1. Field of the Invention

Apparatuses consistent with the present invention relate to a three-dimensional image display apparatus providing a three-dimensional image, and more particularly, to a three-dimensional image display apparatus using a multi-facet flat mirror.

2. Description of the Related Art

In general, holographic displays or stereoscopic displays have been widely used as three-dimensional image displays.

Holographic displays are desirable displays but have problems in that a coherent light source is required and it is difficult to record and reproduce an image of an object far away from an observer.

Stereoscopic displays show two two-dimensional images which have a binocular parallax to an observer's left and right eyes such that the observer's brain recognizes a three-dimensional image due to the binocular parallax. Since stereoscopic displays use two two-dimensional images, embodiments thereof are simple and a three-dimensional image with high resolution and great depth can be displayed. However, since the stereoscopic displays only have horizontal parallax, it is difficult to obtain a three-dimensional image with both horizontal and vertical parallax in a stereoscopic display. Also, since there is inconsistency between a convergence angle of the eyes and a focal point, increased eyestrain may result. In addition, the stereoscopic displays suffer from a discontinuous viewpoint due to fixed single or multiple viewpoints.

Considering the problems of the three-dimensional image displays, image display apparatuses using an integral imaging scheme have been suggested.

In principle, image display apparatuses using the integral imaging scheme store a three-dimensional object in the form of a two-dimensional image array with a lens array comprised of a set of basic lenses, and reproduce an image of the object as a three-dimensional image in reverse order.

Referring to FIG. 1, a conventional three-dimensional image display apparatus using an integral imaging scheme includes an image pickup unit 10 and an image display unit 20.

The image pickup unit 10 includes a first optical array 11 and an image pickup device 15. The image pickup device 15 is an electronic imaging device such as a charge-coupled device (CCD). The image display unit 20 includes an image display unit 21 and a second optical array 25. The image display device 21 is a display capable of reproducing a moving image. The image display device 21 may be a liquid crystal display (LCD), a plasma display panel (PDP), or a cathode-ray tube (CRT).

Here, each of the first and second optical arrays 11 and 25 may be a lens array constructed as shown in FIG. 1, a concave mirror array 31 as shown in FIG. 2, or a convex mirror array 35 as shown in FIG. 3. The concave mirror array 31 shown in FIG. 2 displays image information as a complete real image I_{R}, and the convex mirror array 35 shown in FIG. 3 displays image information as a complete virtual image I_{V}.

As shown in FIGS. 2 and 3, if the concave mirror array 31 or the convex mirror array 35 is used as each of the first and second optical arrays 11 and 25, an image can be displayed on a large screen by a projection method.

The operation of a conventional three-dimensional image display apparatus which uses the integral imaging scheme will be explained with reference to FIG. 1. Each of the first and second optical arrays 11 and 25 is comprised of a plurality of basic lenses whose positions relative to a three-dimensional object O are slightly different from one another. Accordingly, a two-dimensional image array that is formed on the image pickup device 15 after light from the three-dimensional object O passes through the first optical array 11 contains information on images viewed by the basic lenses in different directions. Here, the images viewed by the basic lenses are referred to as basic images, and the two-dimensional image array comprised of the basic images is referred to as a basic image array.

The basic image array is transmitted to the image display unit 20, which is then processed in the reverse order of the procedure listed above. Accordingly, the basic image array is transmitted to the second optical array 25 to be converted into a three-dimensional image, and the three-dimensional image is subsequently displayed on the image display device 21.

A conventional three-dimensional image display apparatus which uses the integral imaging scheme can provide a three-dimensional image having both horizontal and vertical parallax without requiring the use of viewing aids such as polarized glasses. Furthermore, since an image display apparatus which uses the integral imaging scheme provides a continuous viewpoint within a viewing angle differently from the stereoscopic display, a natural three-dimensional image can be reproduced without irregular discontinuity.

However, a conventional three-dimensional image display apparatus which uses the integral imaging scheme has the following problems.

First, a conventional three-dimensional image display apparatus which uses the integral imaging scheme yields a pseudoscopic image with reversed depth since a direction of the image pickup device (e.g., CCD) is directly opposite to a direction of a viewer. As a consequence, the viewer is forced to observe a convex reproduced image when a concave object is captured, and a concave reproduced image when a convex object is captured. Meanwhile, an image display using the convex mirror array shown in FIG. 3 can reproduce an orthoscopic image free of depth reversion.

Second, since the size of each of the basic lenses constituting the first and second optical arrays is limited, the area of a basic image corresponding to each basic lens is also limited. Accordingly, a viewing angle, that is, a visual field within which a reproduced image can be observed, is limited to approximately 20° for each eye. Accordingly, as an F-number of the basic lenses decreases, the viewing angle increases whereas parallax increases, thereby making the distortion of the reproduced image severe. As a result, an image display which uses the integral imaging scheme is limited in the amount which the viewing angle can be increased.

Third, the resolution of the reproduced image is limited by the parallax of the optical array.

Fourth, since the optical array is a convex lens array, a concave mirror array, or a convex mirror array, the manufacturing process is complex and manufacturing costs are high.

### SUMMARY OF THE INVENTION

Aspects of the present invention provide a three-dimensional image display apparatus, which can be easily manufactured and can acquire and reproduce an orthoscopic image with low parallax and high resolution using a multi-facet flat mirror.

According to an aspect of the present invention, there is provided a three-dimensional image display apparatus comprising: an image pickup unit comprising: a first beam splitter changing paths of beams incident from a three-dimensional object; a first multi-facet flat mirror array forming a concave structure with a combination of a plurality of basic flat mirrors which faces the three-dimensional object, wherein the first beam splitter is between the first multi-facet mirror array and the three-dimensional object; and an image pickup device picking up beams which are reflected by the first multi-facet mirror array and pass through the first beam splitter as a two-dimensional basic image signal; and an image display unit comprising: a beam projector receiving the two-dimensional basic image signal from the image pickup device and projecting the received two-dimensional basic image signal; a second beam splitter changing propagation paths of incident beams which are projected; and a second multi-facet flat mirror array forming a concave structure with a combination of a plurality of basic flat mirrors which restores the input two-dimensional basic image signal which is received from the image pickup device into a three-dimensional image signal.

According to another aspect of the present invention, there is provided a three-dimensional image display apparatus comprising: a projector receiving a two-dimensional basic image signal corresponding to a three-dimensional object and projecting the received two-dimensional basic image signal; a beam splitter changing propagation paths of incident beams which are projected; and a multi-facet flat mirror array forming a concave structure with a combination of a plurality of basic flat mirrors and restoring the input two-dimensional basic image signal which is received from the image pickup device into a three-dimensional image signal.

### BRIEF DESCRIPTION OF THE DRAWINGS

The above and other aspects of the present invention will become more apparent by describing in detail exemplary embodiments thereof with reference to the attached drawings in which:

FIG. 1 is a schematic view of a conventional three-dimensional image display apparatus using an integral imaging scheme;

FIGS. 2 and 3 are schematic views illustrating other examples of first and second optical arrays shown in FIG. 1;

FIG. 4 is a schematic view illustrating an optical arrangement of a three-dimensional image display apparatus according to an exemplary embodiment of the present invention;

FIG. 5 is a schematic perspective view illustrating an optical arrangement of an exemplary embodiment of a first multi-facet flat mirror array shown in FIG. 4;

FIG. 6 is a schematic perspective view illustrating an optical arrangement of another exemplary embodiment of the first multi-facet flat mirror array shown in FIG. 4;

FIG. 7 is a schematic view for explaining a principle of obtaining a three-dimensional image using the three-dimensional image display apparatus shown in FIG. 4; and

FIG. 8 is a schematic view illustrating an optical arrangement of a three-dimensional image display apparatus according to another exemplary embodiment of the present invention.

### DETAILED DESCRIPTION OF THE EXEMPLARY EMBODIMENTS OF THE INVENTION

The present invention will now be described more fully with reference to the accompanying drawings, in which exemplary embodiments of the invention are shown.

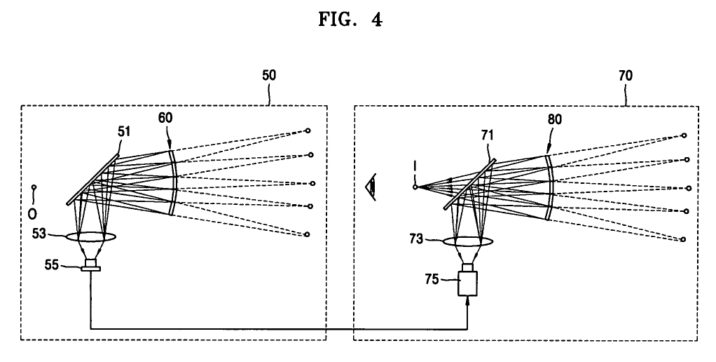

Referring to FIG. 4, a three-dimensional image display apparatus according to an exemplary embodiment of the present invention includes an image pickup unit 50 picking up a two-dimensional basic image signal from a three-dimensional object O, and an image display unit 70 restoring the obtained image signal and reproducing a three-dimensional image.

The image pickup unit 50 includes a first beam splitter 51 changing a path of a beam incident from the three-dimensional object O, a first multi-facet flat mirror array 60 facing the object O with the first beam splitter 51 therebetween, and an image pickup device 55.

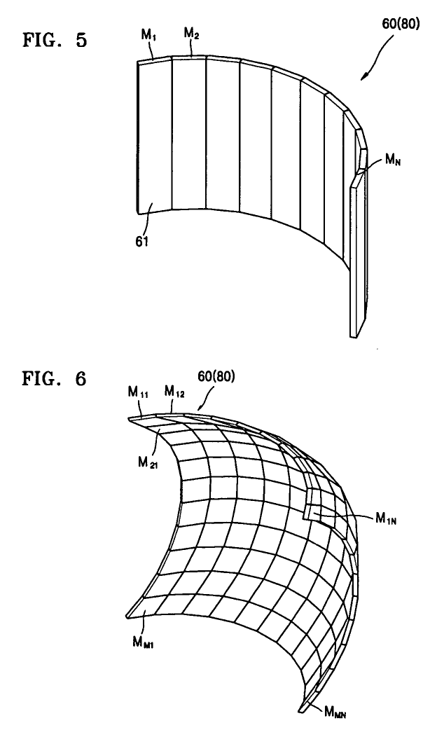

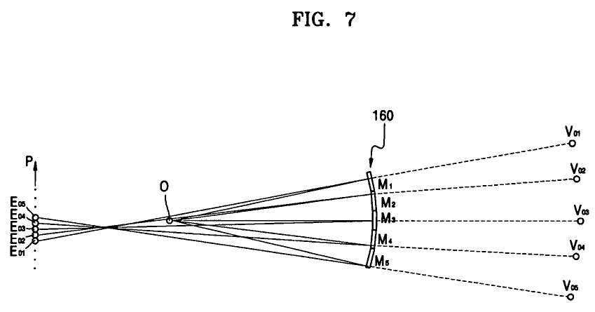

The first multi-facet flat mirror array 60 is comprised of a plurality of basic flat mirrors having different angles of reflection. To this end, the basic flat mirrors are combined to form a concave structure disposed on a spherical, parabolic, elliptical or cylindrical inner surface. The first multi-facet flat mirror array 60 may be arranged as shown in FIGS. 5 and 6.

Referring to FIG. 5, the first multi-facet flat mirror array 60 includes a plurality of basic flat mirrors 61 each having a stripe shape. The plurality of basic flat mirrors 61 are adjoined on a cylindrical inner surface with a curvature in a horizontal direction as shown in FIG. 5. That is, if N basic flat mirrors 61 are prepared and numbers M₁ through M_{N} are given to the basic flat mirrors 61 from left to right in FIG. 5, the basic flat mirrors M₁ through M_{N} are arranged along the curved surface. Accordingly, images reflected by the basic flat mirrors 61 are formed on different positions. Here, the plurality of basic flat mirrors 61 may be arranged in a vertical direction instead of the horizontal direction.

Referring to FIG. 6, the first multi-facet flat mirror array 60 is comprised of a plurality of basic flat mirrors 65 having a polygonal shape. The plurality of basic flat mirrors 65 are adjoined on a concave inner surface with a curvature in both horizontal and vertical directions as shown in FIG. 6. The concave surface may be a spherical, parabolic, or elliptical surface. The basic flat mirrors 65 may have a square shape as shown in FIG. 6, and also may have a diamond, honeycomb, or circular shape. However, if the plurality of basic flat mirrors 65 have a polygonal shape rather than a circular shape, the basic flat mirrors can be immediately adjoined without intervening space to thereby increase a fill factor.

If M×N basic flat mirrors 65 constructed as above are prepared, numbers M₁₁ through M_{M1} are given to the basic flat mirrors 65 from left to right in FIG. 6, and numbers M₁₁ through M_{IN} are given to the basic flat mirrors 65 from up to down in FIG. 6, the basic flat mirrors M₁₁ through M_{MN} are arranged along the curved surface in two dimensions. Accordingly, images reflected by the basic flat mirrors 65 are formed on different positions.

Here, the array of the basic flat mirrors 61 shown in FIG. 5 is more easily manufactured than that of the basic flat mirrors 65 shown in FIG. 6. However, the array of the basic flat mirrors 65 shown in FIG. 6 can obtain both horizontal and vertical parallax.

As described above, since the first multi-facet flat mirror array 60 is comprised of the plurality of basic flat mirrors, the first multi-facet flat mirror array 60 functions to convert image information, that is, a basic image set, obtained in various directions from the three-dimensional object O, whose three-dimensional image is to be obtained, into a two-dimensional basic image signal.

Referring to FIG. 4, the first beam splitter 51 disposed between the object O and the first multi-facet flat mirror array 60 separates incident beams according to a predetermined intensity ratio, and transmits some of the beams and reflects the other beams to change propagation paths of the incident beams. Specifically, the paths of beams used to obtain an image will be explained. Beams incident from the object O are directed toward the first multi-facet flat mirror array 60, reflected by the first multi-facet flat mirror array 60, and then propagate toward the image pickup device 55. Here, for the purpose of preventing the image pickup device 55 from being reflected by the first multi-facet flat mirror array 60 during the process of obtaining an image, the beam splitter 51 and the image pickup device 55 may be arranged so that beams which are reflected by the beam splitter 51 among the beams incident from the first multi-facet flat mirror array 60 can be directed toward the image pickup device 55.

The image pickup device 55 picks up the beams as a two-dimensional basic image signal. The beams are reflected by the first multi-facet flat mirror array 60 and transmitted through the first beam splitter 51. That is, the image pickup device 55 as an imaging device such as a charge-coupled device (CCD) stores the two-dimensional basic image signal which is obtained through the first multi-facet flat mirror array 60.

Further, the image pickup unit 50 may further include a first relay lens 53 disposed on an optical path between the first beam splitter 51 and the image pickup device 55, which focuses and transmits incident beams.

The image display unit 70 receives the two-dimensional basic image signal stored in the image pickup device 55 and restores the two-dimensional basic image signal into a three-dimensional image. To this end, the image display unit 70 includes a beam projector 75, a second beam splitter 71, and a second multi-facet flat mirror array 80.

The beam projector 75 is connected to the image pickup device 55 and is adapted to project the two-dimensional basic image signal which is received from the image pickup device 55 toward the second beam splitter 71. Here, a second relay lens 73 corresponding in structure to the first relay lens 53 may be disposed on an optical path between the beam projector 75 and the second beam splitter 71.

The second beam splitter 71 propagates the image which is projected from the beam projector 75 toward the second multi-facet flat mirror array 80 and propagates the image reflected by the second multi-facet flat mirror array 80 toward a top surface I on which an image is to be formed. Since the arrangement and function of the second beam splitter 71 is substantially identical with those of the first beam splitter 51, a detailed explanation thereof will not be given.

The second multi-facet flat mirror array 80 has substantially the same structure as the first multi-facet flat mirror array 60. Accordingly, the second multi-facet flat mirror array 80 restores the two-dimensional basic image signal and reproduces a three-dimensional complete image. Since the construction of the second multi-facet flat mirror array 80 is substantially identical with that of the first multi-facet flat mirror array 60, a detailed explanation thereof will not be given.

In the meantime, the second multi-facet flat mirror array 80 does not need to be absolutely identical with the first multi-facet flat mirror array 60. That is, even though the first and second multi-facet flat mirror arrays 60 and 80 have different arrangement and structure, a three-dimensional image signal can be reproduced from a two-dimensional basic image through a scaling process. Accordingly, modifications can be made within the confinements described in FIGS. 5 and 6.

A principle of obtaining a three-dimensional image using the plurality of basic flat mirrors adjoined on the two-dimensional surface shown in FIG. 5 will be explained with reference to FIG. 7. The operation of the three-dimensional image display apparatus according to an exemplary embodiment of the present invention will be explained with reference to FIG. 4.

Referring to FIG. 7, virtual images V₀₁ through V_{0N} of the object O in a space can be observed using beams that are reflected by the basic flat mirrors M₁ through M_{N} which constitute the first multi-facet flat mirror array 160. FIG. 7 exemplarily shows only five basic flat mirrors M₁ through M₅ (N=5) and only five virtual images V₀₁ through V₀₅.

If it is assumed that the image pickup device is a pinhole camera, the beams which are reflected by the first multi-facet flat mirror array 160 are transmitted through a pinhole and then are recorded on a flat recording surface P of the pinhole camera, thereby obtaining basic image signals E₀₁ through E₀₅ of the object O. Here, the basic image signals E₀₁ through E₀₅ are signals with respect to one point of the object O. In the same manner, basic image information on another point different in position and depth from the one point of the object O can be obtained. Since the basic image information of the two points with different depths are differently encoded, the original two points can be reproduced if they are decoded in reverse order.

Accordingly, basic image signals for a plurality of points constituting the three-dimensional object are obtained in the above manner, and then the basic image signals which are obtained are decoded in reverse order, thereby providing the original three-dimensional object O.

The three-dimensional image display apparatus as shown in FIG. 4 can display a three-dimensional image based on the three-dimensional image obtaining principle.

Referring to FIGS. 4 through 6, scattered beams from the three-dimensional object O propagate in various directions, pass through the first beam splitter 51 to be directed toward the first multi-facet flat mirror array 60, and are reflected by the first multi-facet flat mirror array 60. Since the basic flat mirrors 61 or 65 which constitutes the first multi-facet flat mirror array 60 have different positions, the reflected beams contain information obtained by viewing the three-dimensional object O in various directions. The beams which are reflected by the first multi-facet flat mirror array 60 are reflected by the first beam splitter 51 and recorded and stored as a two-dimensional basic image signal in the image pickup device 55. The stored two-dimensional basic image signal is then transmitted to the image display unit 70.

The signal transmitted to the image display unit 70 is projected in the form of a two-dimensional basic image by the beam projector 75. The projected beams are reflected by the second beam splitter 71, which are then incident on and reflected by the second multi-facet flat mirror array 80.

The beams which are reflected by the second multi-facet flat mirror array 80 are restored into a three-dimensional image from the two-dimensional image signal, propagate toward the second beam splitter 71 again, pass through the second beam splitter 71, and form a three-dimensional image on a predetermined position on the top surface I.

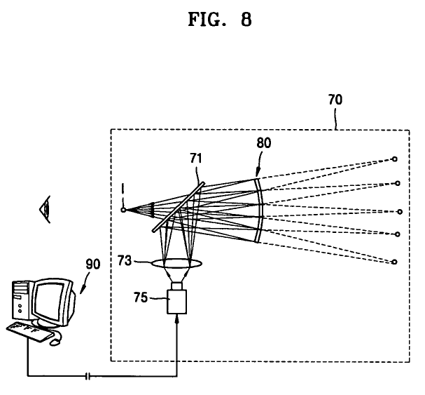

Referring to FIG. 8, a three-dimensional image display apparatus according to another exemplary embodiment of the present invention is different from the three-dimensional image display apparatus illustrated in FIG. 4 in that a structure for obtaining a two-dimensional basic image signal is changed. That is, the three-dimensional image display apparatus illustrated in FIG. 8 generates a two-dimensional basic image signal using a computer graphic procedure and transmits the two-dimensional basic image signal which is generated to the image display unit 70.

The image display unit 70 receives the second basic image signal from a computer 90 and restores the same into a three-dimensional image. To this end, the image display unit 70 includes a beam projector 75, a beam splitter 71, and a second multi-facet flat mirror array 80. A relay lens 73 may be disposed on an optical path between the beam projector 75 and the beam splitter 71. Here, since the structure and function of the image display unit 70 is substantially identical with the image display unit 70 illustrated in FIG. 4, a detailed explanation thereof will not be given.

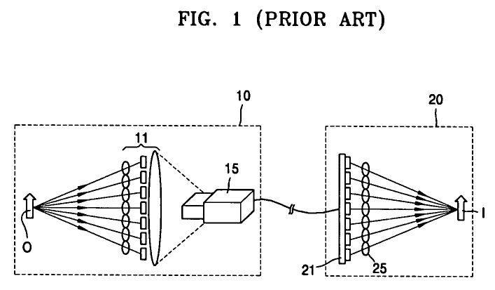

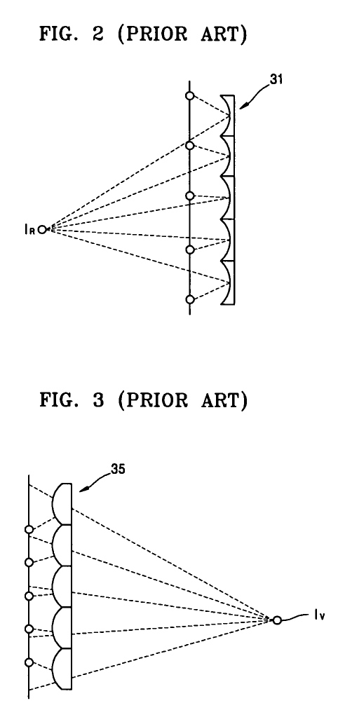

The two-dimensional basic image signal is generated using the computer graphic procedure on the assumption that scattered beams from a virtual three-dimensional object, which is to be restored into a three-dimensional image, are reflected by the multi-facet flat mirror array 80 and then photographed as a two-dimensional image by a camera which corresponds to a image pickup device of FIG. 1. Since the two-dimensional basic image is generated using the computer graphic procedure and then transmitted to the image display unit, the overall construction can be simplified. Furthermore, since the two-dimensional basic image signal is generated considering a pseudoscopic image, the pseudoscopic image can be avoided.

As described above, the three-dimensional image display apparatus according to aspects of the present invention provides a three-dimensional image using the multi-facet flat mirror array comprised of the plurality of basic flat mirrors, the apparatus can use a projection type displays such as a beam projector, and thus a reproduced image can be displayed on a large screen. Moreover, since the multi-facet flat mirror array is a combination of the plurality of flat mirrors, the manufacturing process is simple and manufacturing costs are low. In addition, since parallax problems do not occur, image quality can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A three-dimensional image display apparatus comprising:
an image pickup unit which comprises:
a first beam splitter which changes paths of beams which are incident from a three-dimensional object;
a first multi-facet flat mirror array forming a concave structure with a combination of a plurality of basic flat mirrors which faces the three-dimensional object, wherein the first beam splitter is between the first multi-facet flat mirror array and the three-dimensional object; and
an image pickup device which picks up beams that are reflected by the first multi-facet flat mirror array and pass through the first beam splitter as a two-dimensional basic image signal; and
an image display unit which comprises:
a beam projector which receives the two-dimensional basic image signal from the image pickup device and projects the two-dimensional basic image signal which is received;
a second beam splitter which changes propagation paths of incident beams which are projected; and
a second multi-facet flat mirror array forming a concave structure with a combination of a plurality of basic flat mirrors which restores the two-dimensional basic image signal which is received from the image pickup device into a three-dimensional image signal.

2. The three-dimensional image display apparatus of claim 1, wherein the plurality of basic flat mirrors respectively have stripe shapes and are adjoined on a cylindrical surface with a curvature in a horizontal or vertical direction such that the plurality of basic flat mirrors have different angles of reflection.

3. The three-dimensional image display apparatus of claim 1, wherein the plurality of basic flat mirrors are adjoined on a parabolic or elliptical surface with a curvature in both horizontal and vertical directions such that the plurality of basic flat mirrors have different angles of reflection.

4. The three-dimensional image display apparatus of claim 3, wherein a shape of the plurality of basic flat mirrors respectively is one of a square shape, a diamond shape, a honeycomb shape, or a circular shape.

5. A three-dimensional image display apparatus comprising:
a projector which receives a two-dimensional basic image signal which corresponds to a three-dimensional object and projects the two-dimensional basic image signal which is received;
a beam splitter changing propagation paths of incident beams which are projected; and
a multi-facet flat mirror array forming a concave structure with a combination of a plurality of basic flat mirrors which restores the two-dimensional basic image signal which is received from the image pickup device into a three-dimensional image signal.

6. The three-dimensional image display apparatus of claim 5, wherein the two-dimensional basic image signal is generated using a computer graphic procedure in which scattered beams which are incident from a virtual three-dimensional object, which is to be restored into a three-dimensional image, are reflected by the multi-facet flat mirror array and then photographed as a two-dimensional image.

7. The three-dimensional image display apparatus of claim 6, wherein the plurality basic flat mirrors respectively have stripe shapes and are adjoined on a cylindrical surface with a curvature in a horizontal or vertical direction such that the plurality of basic flat mirrors have different angles of reflection.

8. The three-dimensional image display apparatus of claim 6, wherein the plurality of basic flat mirrors are adjoined on a spherical, parabolic or elliptical surface with a curvature in both horizontal and vertical directions such that the plurality of basic flat mirrors have different angles of reflection.

9. The three-dimensional image display apparatus of claim 8, wherein a shape of the plurality of basic flat mirrors respectively is one of a square shape, a diamond shape, a honeycomb shape, or a circular shape.

10. The three-dimensional image display apparatus of claim 5, wherein the plurality of basic flat mirrors respectively have stripe shapes, and the plurality of basic flat mirrors are adjoined on a cylindrical surface with a curvature in a horizontal or vertical direction such that the plurality of basic flat mirrors have different angles of reflection.

11. The three-dimensional image display apparatus of claim 5, wherein the plurality of basic flat mirrors are adjoined on a spherical, parabolic, or elliptical surface with a curvature in both horizontal and vertical directions such that the plurality of basic flat mirrors have different angles of reflection.

12. The three-dimensional image display apparatus of claim 11, wherein a shape of the plurality of basic flat mirrors respectively is one of a square shape, a diamond shape, a honeycomb shape, and a circular shape.
